(19) United States
(12) Patent Application Publication
(10) Pub. No.: US 2017/0191618 A1
(43) Pub. Date: Jul. 6, 2017

(54) METHOD FOR MANUFACTURING A PRESSURE VESSEL

(71) Applicant: Hydac Technology GmbH, Sulzbach/Saar (DE)

(72) Inventors: Peter KLOFT, Ransbach-Baumbach (DE); Herbert BALTES, Losheim (DE)

(21) Appl. No.: 15/314,522

(22) PCT Filed: Jun. 5, 2015
(86) PCT No.: PCT/EP2015/001142

§ 371 Date: Nov. 29, 2016

(30) Foreign Application Priority Data
Jun. 13, 2014 (DE) 10 2014 008 649.6

(51) Int. Cl. F17C 1/16; F17C 1/06

(52) U.S. Cl. CPC F17C 1/16; F17C 1/06

(57) ABSTRACT

A method for manufacturing a pressure vessel (2), which is preferably provided for use in bladder accumulators, comprising the following manufacturing steps:—providing a support structure (22), more particularly in the form of a liner;—applying a fibrous material (24) to the support structure (22) to form a base structure (20);—placing the base structure (20) in a heatable mold apparatus (4, 6, 10); and—introducing a matrix between the mold apparatus (4, 6, 10) and the base structure (20), which partially penetrates the fibrous material (24).

The invention relates to a method for manufacturing a pressure vessel, which is preferably provided for use in hydropneumatic accumulators, such as bladder accumulators.

Pressure vessels used to store liquid or gaseous media are used in various forms, for example, as hydropneumatic accumulators, in many technical systems in which pressure fluids are used as operating media. In an effort to produce pressure vessels in an economical and cost-effect manner, which provide high structural strength at low material costs and, at the same time, with low structural weight, i.e., which are distinguished by compressive strength, in particular also over long-term operation, it is prior art to manufacture such pressure vessels with a composite construction. In this method, a support structure forming a vessel core, referred to technically as a liner, is formed as one vessel component. In order to obtain a vessel base structure that provides the desired structural strength, despite the small wall thickness of the liner, an outer fiber reinforcement having fibers of high tensile strength is applied to the liner.

Based on this prior art, the object of the invention is to demonstrate a method, according to which pressure vessels with a composite structure that are distinguished by high structural strength despite the minimal structural weight, may be particularly economically and cost-effectively manufactured.

This object is achieved according to the invention by a method, which includes the features of claim 1 in its entirety.

Accordingly, in addition to the formation of the base structure consisting of a liner having an outer fiber reinforcement, the invention provides that this base structure is introduced into a heatable mold apparatus, and that a matrix is introduced between the mold apparatus and the base structure, which at least partially penetrates the fibrous material. By inserting the base structure with the fibrous material on the outside in a heatable mold apparatus and by introducing the matrix into the intermediate space formed between the mold apparatus and the base structure, it is possible within a relatively short reaction time to obtain a fiber composite material in a molding process, in which the fibers are impregnated. A high compressive strength is achievable at a particularly low structural weight with a supporting sheath formed in this way.

Since the composite material containing the matrix is first formed in the invention in the mold apparatus after the fibrous material is applied, this raises the advantageous possibility of applying the fibrous material dry to the support structure, the liner, which may take place in the dry state of the fibrous material in a simple and economical manner by wrapping or laying fabrics or by braiding, wherein the process may be easily take place in axial and/or tangential winding directions. In the case of axial wrapping in the cylindrical part of the liner, fiber longitudinal axes at an angle of 0° to 25° to the cylindrical longitudinal axis may be advantageously provided, wherein the so-called polar caps at the ends of the liner may also be uniformly wound with the axial wrapping. Thereafter or prior thereto, preferably alternatingly, an axial and tangential wrapping of the liner may take place.

The procedure is advantageously such that the liner is wrapped with the fibrous material in the axial and tangential direction in such a way that the fibrous material is substantially subjected to tensile loads.

In particularly advantageous exemplary embodiments, reactive matrix systems, reactive resin systems, reactive polyamides, preferably caprolactam, or polyurethane systems (PU) are used as the matrix.

The matrix is injected into the mold apparatus in a particularly advantageous manner by means of a resin-injection method, preferably under a pressure of 30 bar to 40 bar. This known molding method is technically referred to as RTM, short for resin transfer molding.

In order to lend the matrix a consistency favorable for injection, the matrix is introduced, preferably together with at least one solvent, preferably in the form of isocyanate, into the mold apparatus in such a way that the solvent-containing matrix saturates the fibrous material on the support structure and, in the cured state, the matrix protectively encloses the fibrous material.

The molding process is preferably carried out in the mold apparatus in such a way that the matrix is fully cured after removal from the mold apparatus and is manufactured in a non-porous manner as a solid protective sheath body. The non-porous design of the matrix prevents air present in the matrix from dissolving finely dispersed in the matrix under high compressive loads.

In advantageous exemplary embodiments, a negative pressure is applied to the mold apparatus to facilitate the injection process as the solvent-containing matrix is being introduced and/or the interior pressure of the support structure is increased, preferably by introducing a non-reactive compressible or incompressible pressure medium, such as nitrogen or water or oil, into the support structure.

The molding temperature selected is preferably below 100° C., wherein the molding time is less than 10 minutes, preferably approximately 8 minutes.

A release agent, such as Indrosil®2000 of Indroma Chemikalien, Bad Soden, Germany, may be used In order to facilitate the demolding process. The release agent may also be “built into” the matrix and thus be an integral component of the matrix.

A liner made of a steel material or a liner constructed from plastic materials may be used as the support structure, and which is designed in either case as a hollow body provided with a through-opening at its opposite ends.

In the case of a liner formed from a plastic material, the former may preferably be formed from polyamide or polyethylene, for example, by means of a blow molding process or by rotational sintering. Such manufacturing methods are common and will not be further discussed here. The formation of the liner from metallic material, for example in a composite construction, is likewise prior art.

The subject matter of the invention is also a pressure vessel, which is manufactured, in particular, by a method according to claims 1 through 10, and which includes the features of claim 11.

The invention is explained in detail below with reference to the appended drawings, in which:

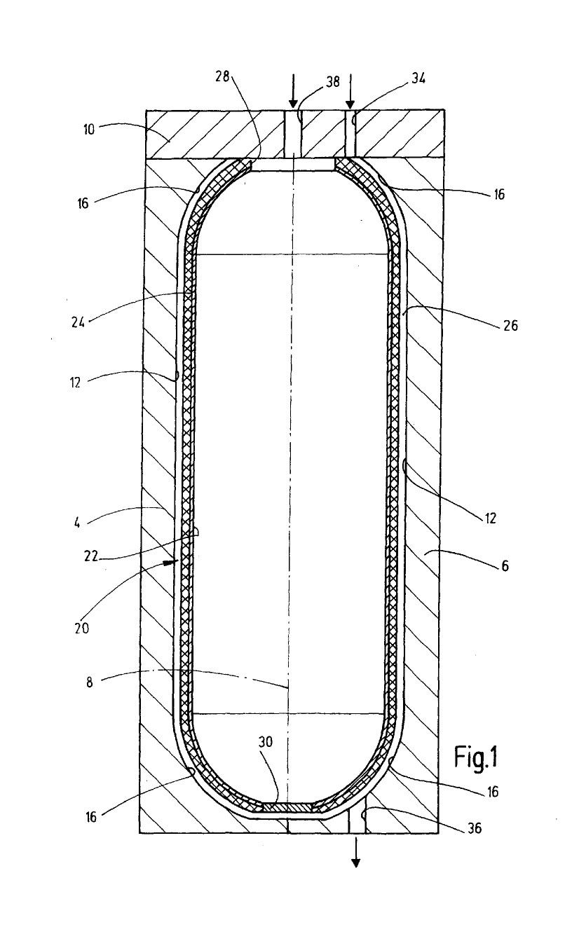

FIG. 1 shows in longitudinal section and in schematically greatly simplified and basic representation a mold apparatus for carrying out the method according to the invention, wherein a vessel base structure is inserted into the mold apparatus as a semi-finished product of a pressure vessel to be manufactured;

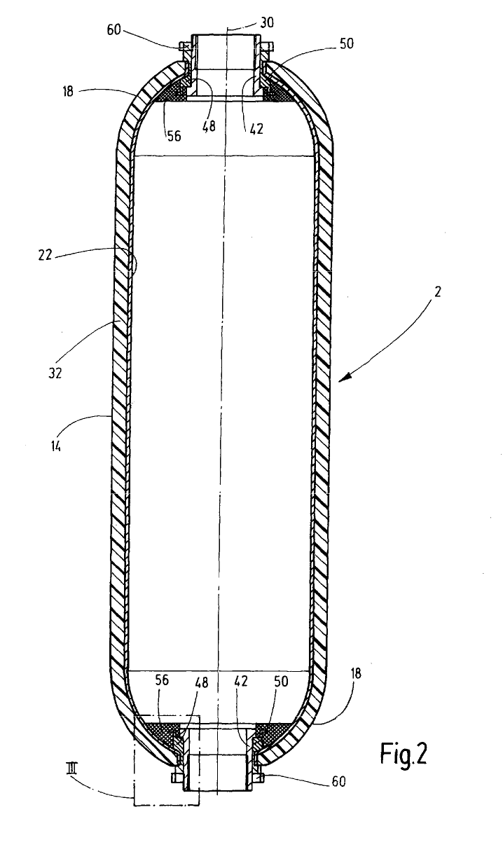

FIG. 2 a longitudinal section of the pressure vessel manufactured by the method according to the invention; and

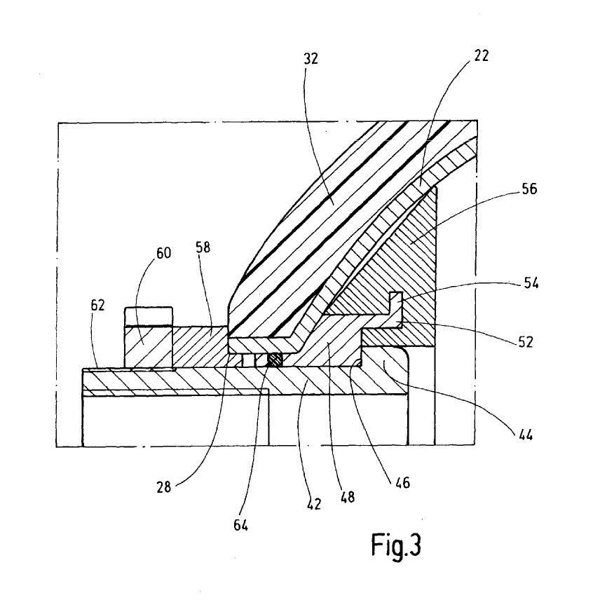

FIG. 3 an enlarged delineated detail of the area identified by III in FIG. 2.

FIG. 1 shows a schematically simplified representation of a mold apparatus, by means of which a pressure vessel may be manufactured by the method according to the invention, as it is shown in FIG. 2 and identified there in its entirety by reference numeral 2. The mold apparatus includes two mold parts 4 and 6 as mold halves, which are movable perpendicular to a longitudinal axis 8 toward one another and away from one another. In FIG. 1, the mold parts 4, 6 are shown brought together in the position corresponding to the closed state of the mold. The mold may be closed at its upper end in FIG. 1 by a moveable top part 10, which is depicted in the closed position. The inner mold walls of the mold parts 4, 6, which define the external shape of the finished pressure vessel, include for each molded part 4, 6 a center semi-cylindrical main part 12, which forms the cylindrical part 14 of the finished pressure vessel 2, and curved end parts 16 attached to the main part 12, which form the polar caps 18 at the ends in the finished pressure vessel 2. The mold parts 4, 6 and the top part 10 are heatable. Heating devices of state-of-the-art design, which may be formed, for example, by imbedded electrical heat conductors or ducts for the passage of a heating medium, such as steam, are not depicted in FIG. 1.

The vessel base structure 20 is inserted as the semi-finished product in the opening mold apparatus (FIG. 1) and is appropriately fixed therein (not depicted), after which the mold apparatus is closed, as is shown in FIG. 1. The base structure 20 consists of the liner 22 forming the support structure or the vessel core, on which the fiber reinforcement 24 is situated. During prefabrication of the base structure 20, the liner 22 is manufactured in a manner known per se from a metallic material, such as steel or aluminum, or from a plastic, such as polyamide or polyethylene, wherein a blow molding method or rotational sintering is suitable in this case.

The fiber reinforcement 24 is applied during prefabrication of the base structure 20 by wrapping or braiding the liner 22 with the dry fibrous material. The material used may be fibers made of carbon, aramid, glass, boron or textile fibers, hybrid yarns or natural fibers, such as basalt, flax, hemp or cotton bamboo or the like, may also be considered. The dry application of the fibrous material takes place in the form of a wrapping or a braiding the of liner 22 in axial and tangential winding directions, wherein in the axially extending winding areas, the orientation of the winding direction when wrapping the cylindrical part 14 is preferably 0° to 25° relative to the cylindrical axis and the axial wrapping also extends uniformly over the pole caps 18. Tangential wrappings as an alternative to axial wrappings take place beforehand or subsequently, wherein the structuring of the winding takes place in such a way that the fibrous material is preferably subjected to tensile loads.

As shown in FIG. 1, an intermediate space 26 is formed in the closed mold apparatus between the inner mold walls of the mold parts 4, 6 and the outer side of the fiber reinforcement 24, and which completely surrounds the outer side of the fiber reinforcement 24 between the open end 28 of the base structure 20 situated above in FIG. 1 down to the bottom end closed by a closure part 30. In this intermediate space 26, a matrix is introduced, which saturates the dry fiber reinforcement 24, from which, after it has fully cured, a solid protective sheath body 32 is formed, see FIGS. 2 and 3. To introduce the matrix in a consistency suitable for an injection process, an inlet opening 34 is provided on the top part 10 of the mold apparatus, which opens into the intermediate space 26.

Reactive resin systems, reactive polyamides, preferably caprolactam, or polyurethane systems (PU) are used as the matrix, wherein a solvent, such as isocyanate, is preferably added in order to facilitate the saturation of the fibrous material. The air displaced during the injection is discharged via a suction connection 36 provided on mold part 16 located below in FIG. 1, at which a negative pressure is present for boosting the injection process. To carry out a resin injection method (RTM), the matrix is injected under pressure at a temperature of the mold apparatus, which is in the range of 70° C. to 90° C. or even higher. To avoid a deformation of the base structure 20 as a result of the injection pressure, an overpressure is built up in the interior of the liner 22 during the injection process. For this purpose, the top part 10 includes a pressure connection 38, via which supporting air, such as nitrogen gas, is fed. However, the support structure or the liner 22 is preferably filled with an incompressible fluid, water or oil.

Following a reaction time of less than 10 minutes, preferably of approximately 8 minutes, the mold apparatus is opened and the pressure vessel 2 with its protective sheath body 32 is removed, which is formed from the fibrous material impregnated with the matrix and which is non-porous in the fully cured state. After removal of the closure part 30, the pressure vessel 2 formed may be provided at both opposite ends with a connection fitting common for such vessels.

FIGS. 2 and 3 shows the finished pressure vessel 2 with connection fittings, each of which is formed by a pipe socket 42 in the form of a so-called standardized SAE flange. FIG. 3 shows in an enlarged representation further details of the identically designed pipe socket 42 on both ends of the vessel. As is apparent, said pipe socket includes a collar 44 at its inner end, which forms a shoulder surface 46 as a contact surface for a half-ring 48. The half-ring 48, together with an identically designed second half-ring 40 (FIG. 2), forms an annular body surrounding the pipe socket 42. Each half-ring 48, 50 includes a retaining ring 52 protruding axially in the direction of the vessel interior with a radially protruding end edge 54. The latter forms a type of securing hook, which secures by hooking said retaining ring by engaging in a slotted opening of a ring disc 56.

Mounted outside the half-rings 48, 50 on the outer side of the pipe socket 42 is a compression ring 58, which is supported at the open end 28 on the liner 22. A nut 60, which is seated on an outer thread 62 of the pipe socket 42, abuts the outer side of compression ring 58. Tightening the nut 60, which is supported on the liner 22 via the compression ring 58, creates a tensile force in the pipe socket 42 directed from the vessel interior outwardly, which is transferred via the shoulder surface 46 on the collar 44 to the half-rings 48, 50. In this way, the elastomer ring disk 56 is braced against the inner side of the liner 22 via the retaining ring 52 with the radially protruding end edge 52, and forms a seal. A further seal is provided by an O-ring 64 on the inner side of the end section of the liner 22.

Further details of the method according to the invention may be gleaned from the example indicated below.

### Example

A liner provided for a composite pressure vessel is manufactured in a conventional manner with a material weight of 864 g. A vessel base structure is formed by wrapping the liner with fibrous material, the weight of which is 250 g, wherein the wrapping takes place in axial and tangential winding directions to form a fiber reinforcement. The fibrous material used is a high-performance carbon fiber, manufactured by Toho Tenax® with the product designation HTS45 E23 12k with a yarn count of 800 tex.

The wrapped base structure is inserted into a mold apparatus, the basic structure of which is shown in FIG. 1 and which includes the heatable mold parts. To carry out a resin injection method (RTM), a matrix is injected into the intermediate mold space between the fiber reinforcement and the adjoining mold walls at an interior mold temperature of the mold parts of 87° C. and an exterior temperature of the mold parts of 77° C., wherein a vacuum of 200 mbar is present at the intermediate mold space and a supporting pressure of 15 bar is generated in the interior of the liner by means of nitrogen gas.

A matrix in the form of a polyurethane system (PU) is injected, which includes Elastolit® R8819/104/LT of BASF, Ludwigshafen, Germany, as one mixing component, Polyol A.4.D.22.6/196-R1 (tradename Elastolit R8819/104 of BASF) as the second mixing component, and Isocyanate IsoMNDI 92052 as the solvent additive. Also provided is an additive of Indrosil® 2000 of Indroma® Chemikalien, Bad Soden, Germany as a release agent, which facilitates the separation process between the mold and the manufactured mold body when the mold apparatus is opened.

The base structure with the fiber reinforcement saturated by the matrix remains in the closed mold apparatus for a reaction period of 8 minutes. After the mold apparatus is opened, the removed pressure vessel has a fully cured solid, protective sheath body that is non-porous.

1. A method for manufacturing a pressure vessel (2), which is provided preferably for use in bladder accumulators, having the following manufacturing steps:
providing a support structure (22), in particular, in the form of a liner;
applying a fibrous material (24) to the support structure (22) to form a base structure (20);
introducing the base structure (20) into a heatable mold apparatus (4, 6, 10); and
introducing a matrix between the mold apparatus (4, 6, 10) and the base structure (20), which at least partially penetrates the fibrous material (24).

2. The method according to claim 1, characterized in that the fibrous material (24) is applied dry to the support structure (22) and takes place in the form of a wrapping or braiding.

3. The method according to claim 1, characterized in that the support structure (22) is wrapped with the fibrous material (24) in an axial and tangential direction in such a way that the fibrous material (24) is substantially subjected to tensile loads.

4. The method according to claim 1, characterized in that
reactive resin systems;
reactive polyamide, preferably caprolactam; or
polyurethane systems (PU) are used as a matrix.

5. The method according to claim 1, characterized in that the matrix is injected into the mold apparatus (4, 6, 10) by means of a resin injection method, preferably under a pressure of 30 bar to 40 bar.

6. The method according to claim 1, characterized in that the matrix, together with at least one solvent, preferably in the form of isocyanate, is introduced into the mold apparatus (4, 6, 10) in such a way that the solvent-containing, fluidic matrix saturates the fibrous material (24) of the support structure (22) and the matrix in the cured state protectively encloses the fibrous material (24).

7. The method according to claim 1, characterized in that the matrix, fully cured after removal from the mold apparatus (4, 6, 10), is manufactured as a solid protective sheath body (32) in a non-porous manner

8. The method according to claim 1, characterized in that a negative pressure is applied to the mold apparatus (4, 6, 10) during the introduction of the solvent-containing matrix and/or the interior pressure of the support structure (22) is increased, preferably by introducing a non-reactive, compressible or incompressible pressure medium, such as nitrogen gas, or water or oil.

9. The method according to claim 1, characterized in that the molding temperature selected is below 100° C. and the mold time is less than 10 minutes, preferably approximately 8 minutes.

10. The method according to claim 1, characterized in that the support structure used is a liner (22) made of steel materials or a liner (22) constructed from plastic materials, either of which is designed as a hollow body provided with a through-opening (42) at its opposite ends.

11. A pressure vessel, in particular, manufactured by a method according to claim 1, consisting of at least one support structure (22), which is surrounded by a fibrous sheath (24), which is saturated with a matrix, which encloses the fibrous sheath (24) at least partly toward the outside as a protective sheath body (32).
